(19) United States
(12) Patent Application Publication
(10) Pub. No.: US 2014/0117090 A1
(43) Pub. Date: May 1, 2014

(54) System for Preventing an Unauthorized Withdrawal of Objects

(71) Applicant: Oleg Aronov, Rego Park, NY (US)

(72) Inventor: Oleg Aronov, Rego Park, NY (US)

(21) Appl. No.: 14/149,930

(22) Filed: Jan. 8, 2014

Related U.S. Application Data
(63) Continuation-in-part of application No. 12/799,793, filed on Apr. 30, 2010, now Pat. No. 8,400,308.

(51) Int. Cl. G07F 7/08

(52) U.S. Cl. CPC G07F 7/0893
USPC 235/380

(57) ABSTRACT

A system for preventing an unauthorized withdrawal of objects has a securing element attachable to an object, an identification element attachable to the object and identifying at least one parameter of the latter, and a control unit constructed to examine the identification element and to allow removal of the securing element from the object only after the examination of the identification element.

### CROSS REFERENCE TO A RELATED APPLICATION

The application is a continuation-in-part of patent application Ser. No. 12/799,793 filed on Apr. 30,2010 whose subject matter is incorporated here by reference thereto and which provides a basis for priority under 37 CFR 119 (a)-(d).

### BACKGROUND OF THE INVENTION

The present invention relates to a system for preventing an unauthorized withdrawal of object.

It is known that objects for example for sale in stores and the like are provided with security elements to prevent their unauthorized withdrawal, so that taking of an object from the store and the like needs removal of the security element, which is usually carried out by authorized personnel in the store. However, sometimes a person who want to take an object from the store and does not want to pay for it, tries just to remove the security element so that he/she can take the object through a security gate, which usually includes scanners, undetected.

It is believed that there is a need to improve such security system so as to avoid a possibility of thefts in the above described manner.

### SUMMARY OF THE INVENTION

Accordingly it is an object of the present invention to provide a system for preventing an unauthorized withdrawal of objects, which is an improvement of he systems of this type.

In keeping with this object and with others which will become apparent heinafter, one feature of the present invention resides, briefly stated, in a system for preventing an unauthorized withdrawal of an object, comprising a securing element attachable to an object; an identification element attachable to an object and identifying the object by at least one parameter; and control means operational to receive a signal when the identification element is identified by an authorized person and to act of the securing element to allow a release of the latter only after the authorized person examines the identification element.

When the system is designed in accordance with the present invention, the securing element can not be removed from the object by an unauthorized person, and the removal of the securing element from the object is possible only after the identifying element is examined by an authorized person, for example by a cashier in the store, who identifies the identifying element and for example takes a payment from a potential buyer of the object.

The control means of the inventive system can be formed as a scanner which scans the identifying element, and the identifying element can be formed as a known barcode which is scannable by the scanner during the operation of the system in accordance with the present invention.

The new features of the present invention are specifically defined in the appended claims.

The invention itself however both as to its construction and its manner of operation will be best understood from the following description of the invention which is accompanied by the following drawings.

### BRIEF DESCRIPTION OF THE DRAWINGS

FIG. 1 of the drawings is a schematic view showing a system for preventing an unauthorized withdrawal of objects and includes a securing element and an identifying element attachable to an object and interacting with each other in an inventive manner.

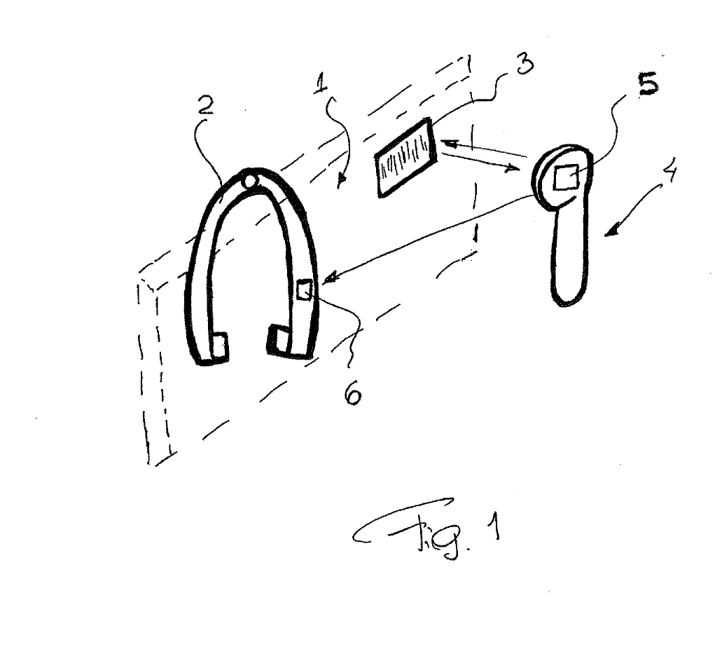

### DESCRIPTION OF THE PREFERRED EMBODIMENTS

A system for preventing an unauthorized withdrawal of object includes a securing element which is identified as a whole with reference numeral 1. The securing element 1 is attachable to an object 2, As known in the art, the securing element 1 is constructed so that if it is attached to the object 2 and not removed from the object 2, and if the object 2 with the attached securing element 1 is attempted to be taken from a store or the like an alarm signal is generated by a control equipment which form example is located at an exit door of the store.

As also well known in the art, the securing element 1 constructed to be converted from an open position outside of the object 2 to a closed position in which it is closed on the object 2 and can not be easily removed by an unauthorized person, and then again to an open position to remove the securing element 1 from the object. The securing element 1 can be formed for example as an openable and closeable electromagnetic lock.

The system in accordance with the present invention further has an identifying element 3 which is attachable to the object and carries at least one identifying parameter of the object 2. The identifying element 3 can be formed as a well known barcode which is scannable for example with a scanner 4 by a cashier in a store to determine a price of the object 2 and to collect a payment from a buyer.

The system in accordance with the present invention further has control means formed, in combination with the securing element 1 and the identifying element 3 so that the securing element 1 can be opened and removed from the object 2 only after examination of the identifying element 3, for example scanning of the latter. The control means can include a transceiver 5 and a receiver 6 and can operate in the following manner.

The transceiver 5 of the scanner 4 sends an identification signal to the identification element 3, scans the identification element, for example the barcode, provided on the object 2, and receives a signal from the identifying element 3. Only upon the reception of this signal, the transceiver 5 of the scanner 4 sends a signal to the securing element 1 and the securing element 1 can be opened by an authorized person or opens automatically.

Therefore in the inventive system the securing element 1 can be opened and removed from the object 2 only after the identifying element 3 on the object 2 is identified or scanned.

The invention is not limited to the details shown since further modifications and structural changes are possible without departing from the spirit of the present invention.

What is desired to be protected by letters patent is set forth in particular in the appended claims.

1. A system for preventing an unauthorized withdrawal of objects, comprising a securing element attachable to an object; an identification element attachable to an object and identifying at least one parameter; and control means constructed to examine the identification element and to release the securing element from the object only after the examination of the identification element.

2. A system as defined in claim 1, wherein said control means include a scanning element which scans said identification element.

3. A system as defined in claim 1, wherein said identification element is a barcode element attacheable to the object.

4. A system as defined in claim 1, wherein said control means include a transceiver which receives a signal from the identification element that the latter was examined and sends a signal to the securing element to open the latter.

5. A system as defined in claim 4, wherein said securing element is configured so that upon receipt of the signal from the transceiver it can be opened or it opens automatically.

6. A method of preventing an unauthorized withdrawal of objects, comprising the steps of attaching a securing element to an object; attaching to an object an identification element which identifies at least one parameter, examining the identification element by control means; and allowing the securing element to be released only after the examination of the identification element
